(19) United States
(12) Patent Application Publication
(10) Pub. No.: US 2021/0210099 A1
(43) Pub. Date: Jul. 8, 2021

(54) Multi Device Proxy

(71) Applicant: SoundHound, Inc., Santa Clara, CA (US)

(72) Inventors: Arvinderpal S. Wander, Fremont, CA (US); Evelyn Jiang, Cupertino, CA (US); Matthias Eichstaedt, San Jose, CA (US); Timothy Calhoun, Santa Clara, CA (US)

(73) Assignee: SoundHound, Inc., Santa Clara, CA (US)

(21) Appl. No.: 16/735,677

(22) Filed: Jan. 6, 2020

(51) Int. Cl. G10L 15/32; G10L 15/22

(52) U.S. Cl. CPC G10L 15/32; G10L 2015/223; G10L 15/22

(57) ABSTRACT

A method and system for responding to multiple voice requests sent from a group of devices in substantive response to a single spoken utterance of a user. In one embodiment, if the devices have a same group ID, a server determines if any of the group of received voice requests are duplicate. In one embodiment, voice requests received within a predetermined time window are examined to determine if they are duplicate. If so, the server deems one of the received voice requests as non-duplicate and the others as duplicate and sends a substantive response for the non-duplicate voice request. In some embodiments, a no-op is sent to the devices that do not receive the substantive response.

### FIELD

The present invention relates to servers for client devices that respond to spoken utterances and, more specifically, to resolving duplicate voice requests coming from more than one device in response to a single spoken utterance.

### BACKGROUND

Users are now able to control devices with spoken utterances. As an example, voice-controlled devices exist that receive a voice query or command, send the query or command as a voice request to a server in the cloud, and receive a substantive response from the server. The voice-controlled device then provides the response to the user.

A problem arises when there are multiple voice-controlled devices in proximity to each other. More than one such device may detect the same spoken utterance from a user and attempt to respond. This often results in multiple devices sending voice requests to a server with audio from the single spoken utterance or in one or more devices that the user does not expect responding to a spoken utterance. It is often problematic for the user if more than one device responds to a single spoken utterance.

### BRIEF DESCRIPTION OF THE FIGURES

The present invention is illustrated by way of example, and not by way of limitation, in the figures of the accompanying drawings and in which like reference numerals refer to similar elements and in which:

FIG. 1(a) is a diagram of an embodiment of the invention.

FIG. 1(b) is a flowchart of a method performed by the embodiment of FIG. 1(a).

FIG. 2(a) is a flowchart of a method used to determine if a voice request is duplicate or non-duplicate in an embodiment of the invention.

FIG. 2(b) is a flowchart of another method used to determine if voice requests are duplicate or non-duplicate in an embodiment of the invention.

FIG. 3(a) is an example data structure of a voice request.

FIG. 3(b) is an example data structure of a substantive response.

FIG. 4(a) is a diagram of an embodiment of the invention.

FIG. 4(b) is a flowchart of a method performed by the embodiment of FIG. 4(a).

FIG. 5 is a flowchart of a high level method performed by an embodiment of the invention.

FIG. 6 is an example of hardware usable in embodiments of the described embodiments of the invention.

### SUMMARY

An embodiment of the present invention comprises a computer-implemented method of processing voice requests that receives a first voice request from a first device in a group of devices; receiving a first voice request from a first device in a group of devices; receiving a second voice request from a second device in the group of devices; deeming one of the first and the second voice requests a non-duplicate voice request and deeming the other of the first and the second voice requests a duplicate voice request; sending a substantive response for the deemed non-duplicate voice request to the device from which the deemed non-duplicate voice request was received; and refraining from sending a substantive response for the deemed duplicate voice request to the device from which the deemed duplicate voice request was received.

In some embodiments, including the embodiment described above, the first and second voice requests further may be deemed to be duplicate only if they are determined to have a same group ID. In some embodiments, including the embodiment described above, a group ID of the group of devices further may be determined dynamically by the group of devices, wherein the determining dynamically may comprise sending an audio signal having a frequency outside of human perception by one of the devices of the group of devices and receiving the audio signal by another device of the group of devices, wherein the one device and the another device determine the group ID based on the signal.

In some embodiments, including the embodiments described above, one or more of the following are further used to deem a duplicate voice request and a non-duplicate voice request. Deeming one of the first and the second voice requests a non-duplicate voice request and deeming the other of the first and the second voice requests a duplicate voice request further comprises performing a “Pick the First” method. Deeming one of the first and the second voice requests a non-duplicate voice request and deeming the other of the first and the second voice requests a duplicate voice request further comprises deeming that the voice request with a highest wake word confidence score is non-duplicate. Performing automatic speech recognition on the first and second voice requests to produce first and second automatic speech recognition confidence scores, wherein deeming one of the first and the second voice requests a non-duplicate voice request and deeming the other of the first and the second voice requests a duplicate voice request further comprises deeming that the voice request whose substantive response has a highest automatic speech recognition confidence score is non-duplicate. Deeming one of the first and the second voice requests a non-duplicate voice request and deeming the other of the first and the second voice requests a duplicate voice request further comprises determining that the voice request whose substantive response has a lowest noise value is non-duplicate. Deeming one of the first and the second voice requests a non-duplicate voice request and deeming the other of the first and the second voice requests a duplicate voice request further comprises determining that the first and second voice requests are from a same source. Determining a volume value for the first voice request and the second voice request; and deeming non-duplicate the voice request whose volume value is highest. In some embodiments, the first and second voice requests may be deemed to be duplicate only if they are determined to have been received within a predetermined time window.

Some embodiments, including the embodiments described above, may further comprise performing natural language processing on the non-duplicate voice request to generate the substantive response.

Some embodiments, including the embodiments described above, may further comprise calling a multi-device proxy for the first and second voice requests; and receiving from the multi-device proxy a determination of which of the first and second voice requests are non-duplicate and duplicate. In one implementation, the first and second voice requests are sent to the multi-device proxy separately, as they are received. In one implementation, the first and second voice requests are sent to the multi-device proxy together, after both have been received.

Some embodiments, including the embodiments described above, may comprise a computer-implemented method of processing voice requests, comprising: receiving a first voice request from a first device in a group of devices; receiving a second voice request from a second device in the group of devices; performing automatic speech recognition and natural language processing on the first voice request to generate produce a first substantive response and on the second voice request to generate produce a second substantive response; deeming one of the first and the second voice requests a non-duplicate voice request and deeming one of the first and the second voice requests a duplicate voice request based on the first and second substantive responses and identifying one of the first and second substantive responses to be sent based on the deeming of the non-duplicate voice request; sending the identified substantive response to a device in the group of devices; and refraining from sending a substantive response for the deemed duplicate voice request to other devices in the group of devices.

In some embodiments, including the embodiments described above, the first and second voice requests further may be deemed to be duplicate only if they are determined to have a same group ID. In some embodiments, including the embodiments described above, a group ID of the group of devices may further be determined dynamically by the group of devices, wherein the determining dynamically may comprise sending an audio signal having a frequency outside of human perception by one of the devices of the group of devices and receiving the audio signal by another device of the group of devices, wherein the one device and the another device determine the group ID based on the signal.

In some embodiments, including the embodiment described above, one or more of the following are further used to deem a duplicate voice request and a non-duplicate voice request. Deeming one of the first and the second voice requests a non-duplicate voice request further comprises determining that the voice request whose substantive response has a lowest noise value is non-duplicate. Deeming one of the first and the second voice requests a duplicate voice request further comprises determining that transcripts of the first and second spoken utterances are identical within a request similarity threshold value. Deeming one of the first and the second voice requests a duplicate voice request further comprises determining that transcripts of the first and second substantive responses are identical within a response similarity threshold value. Deeming one of the first and the second voice requests a non-duplicate voice request further comprises deeming the voice request that has a highest volume value is non-duplicate.

In some embodiments, the first and second voice requests further may be deemed to be duplicate only if they are determined to have been received within a predetermined time window.

In some embodiments, including the embodiments described above, a voice request is received from a third device in the group of devices. In some embodiments, the response may be sent to a third device in the group of devices because the third device is determined to be best able to process the response. In some embodiments, including the embodiments described above, a computer readable medium comprises instructions that, when implemented by the computer, cause the computer to carry out the methods described herein.

### DETAILED DESCRIPTION

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be used and that logical, mechanical, electrical, functional and other changes may be made without departing from the scope of the present invention. The following detailed description is, therefore, not to be taken in a limiting sense, and the scope of the present invention is defined only by the appended claims.

A. Overview

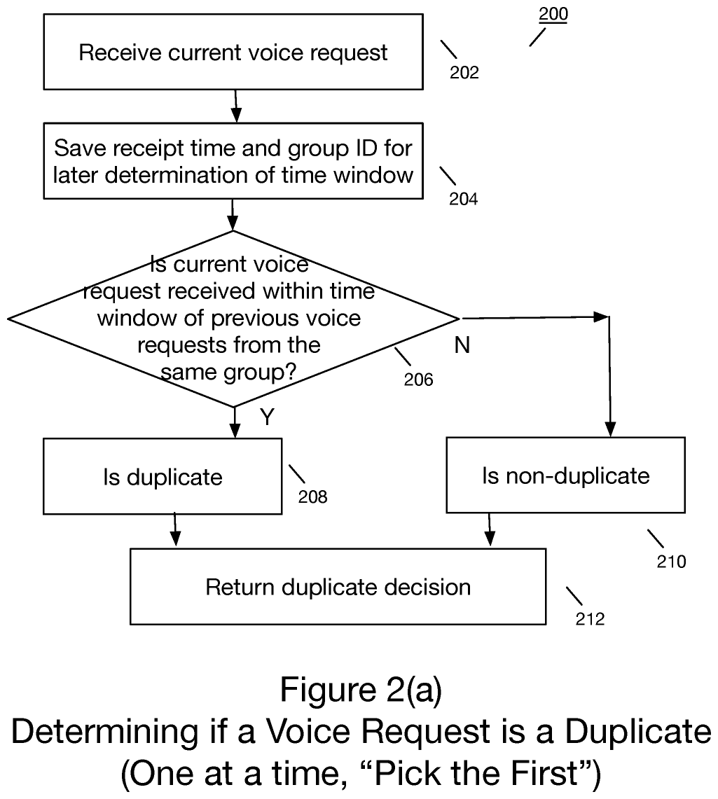

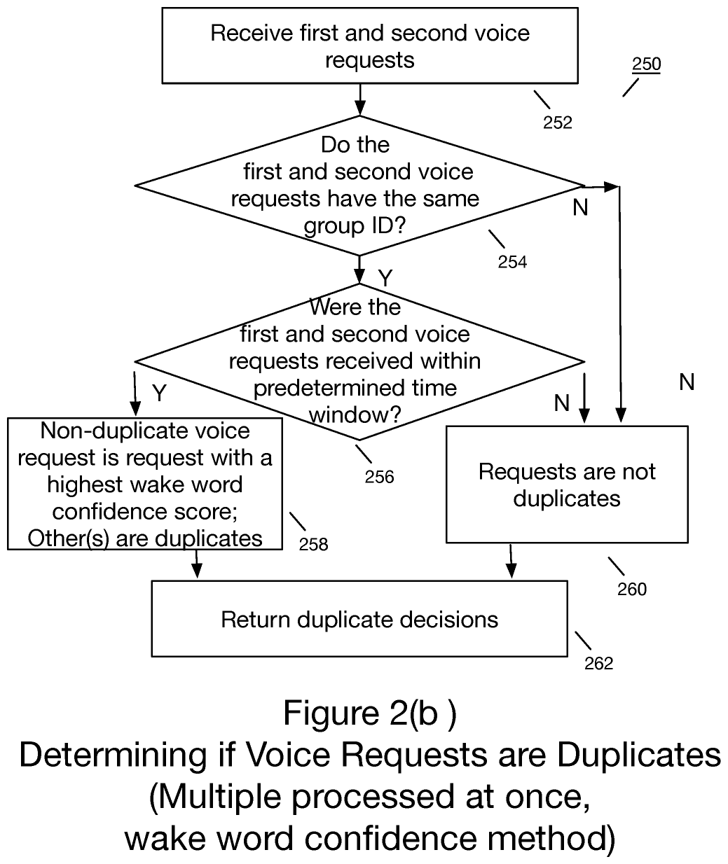

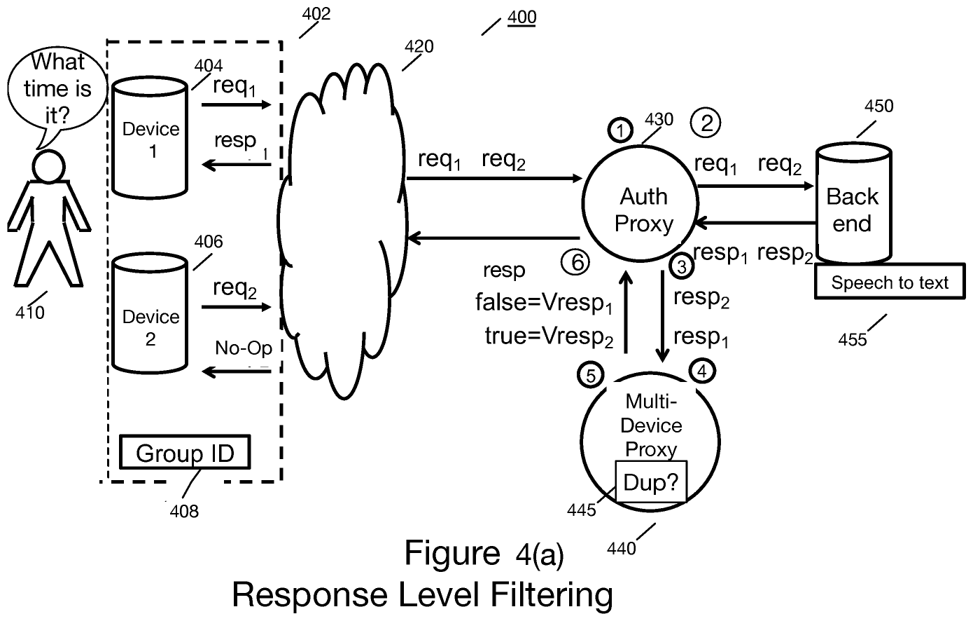

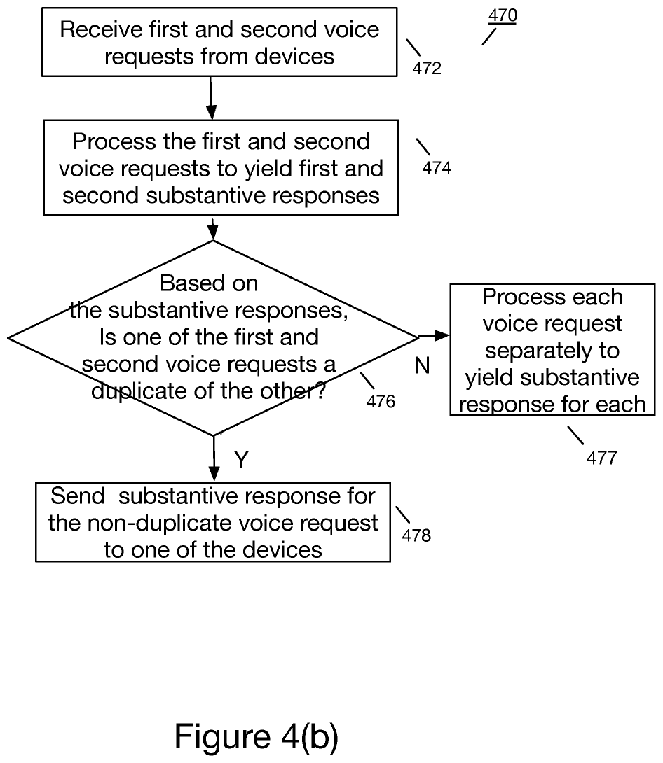

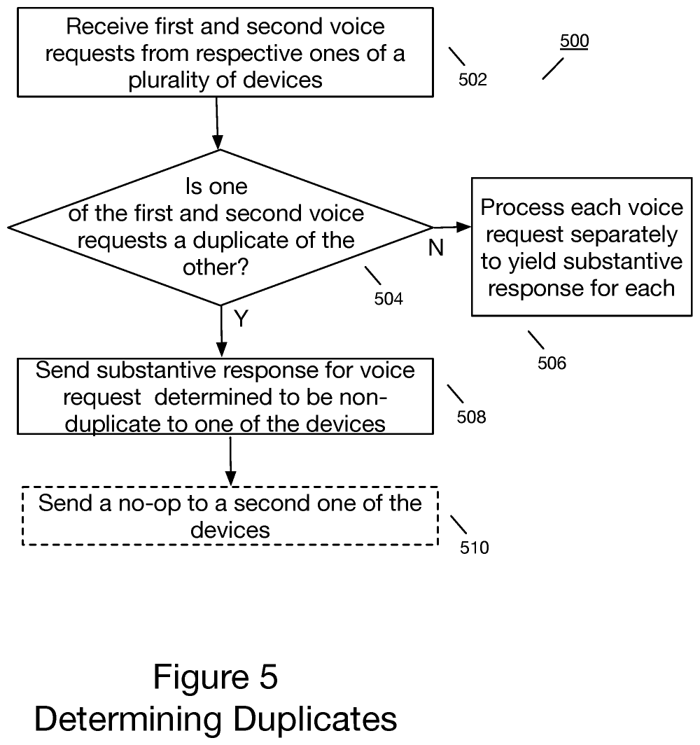

FIG. 5 is a flowchart 500 of a high level method performed by an embodiment of the invention, including but not limited to the methods of FIGS. 2(a), 2(b), 4(a), and 4(b). Reference numbers from those Figures and FIG. 5 are used in the discussion below. In one implementation, the method is performed by an Authorization Proxy (AP) 130/430 and Multi-Device Proxy (MDP) 140/440. An Authorization Proxy is a layer 7 proxy that terminates, authenticates, and regulates voice requests. It routes voice requests to an appropriate backend services based on REST API URL and/or application level content. Here, “regulate” comprises, for example, traffic control, rate limit control etc. A Multi-Device Proxy provides services to identify duplicate voice requests, and determines better substantive responses between duplicate voice requests. In element 502, at least first and second voice requests are received from respective ones of a group of devices such as group of devices 102/402. In at least one embodiment, AP 130/430 determines 504 whether one of the first and second voice requests is a duplicate of the other, i.e., whether they are resulting from a same spoken utterance of a user. A spoken utterance may be a spoken command (such as “tell me a joke”), a spoken query (such as “What time is it?”), a spoken voice request to control a device (such as “turn up the volume”), etc. Examples of spoken utterances include but are not limited to spoken requests or commands to play music, provide information, deliver news and sports scores, tell you the weather, control a smart home, and buy items online.

If one of the first and second voice requests is not determined to be a duplicate of the other, they are each processed separately in a normal manner 506. If multiple voice requests are determined to be from a same spoken utterance, one voice request is deemed non-duplicate and the other voice request(s) are deemed duplicate. A substantive response for the non-duplicate voice request is sent 508 to one of the devices in the group of devices.

Note that, in one embodiment, the substantive response to a non-duplicate voice request is sent to the device sending the non-duplicate voice request. But in other embodiments, as discussed below in more detail, the substantive response is sent to a device different from the device that sent the non-duplicate voice request. Optionally, in some embodiments, a no-operation (no-op) is sent 510 to the device(s) that sent a duplicate voice request to acknowledge that its/their requests were received. In the described embodiment, a no-op is not considered a “substantive response” because it does not provide a substantive response to a voice request. A substantive response is a response that provides an answer to a voice request or instructs an action in response to a voice request. In other embodiments, a no-op is sent to devices other than the device that received a substantive response. In other embodiments, a no-op is not sent, so that devices not receiving a substantive response to a non-duplicate voice request receive no response at all.

If a no-op is sent to a device, in one embodiment, the device takes no action but at least is informed that its voice request was received. In an embodiment, the device receiving a no-op may note that its voice request was deemed duplicate, for example, as a stored error code, as a message to the user on a display, as an audible tone, etc.

In one embodiment, the method also looks at a Group ID 108/408 of the received voice requests. The embodiment only determines 504 whether voice requests are non-duplicate or duplicate(s) if they have a same group ID. Assignment of group IDs is discussed below. As an example, in this embodiment if two users in adjacent hotel rooms speak a same spoken utterance at the same time and if their devices in the respective rooms each have a different group ID, both users will experience a device in their room responding to the spoken utterance. In this embodiment, voice requests must have a same group ID before a determination is made whether they are a non-duplicate or duplicates. As discussed below, some embodiments do not use an explicit group ID but have other ways of indicating that devices are in a group.

The above-described description aims to have only one device provide a substantive response to a user's spoken utterance. A secondary aim is to have the “best” device for the voice request present a substantive response to the user. Note that this may or may not be the device that sent the voice request for which the substantive response is generated.

B. Voice Request Level Filtering

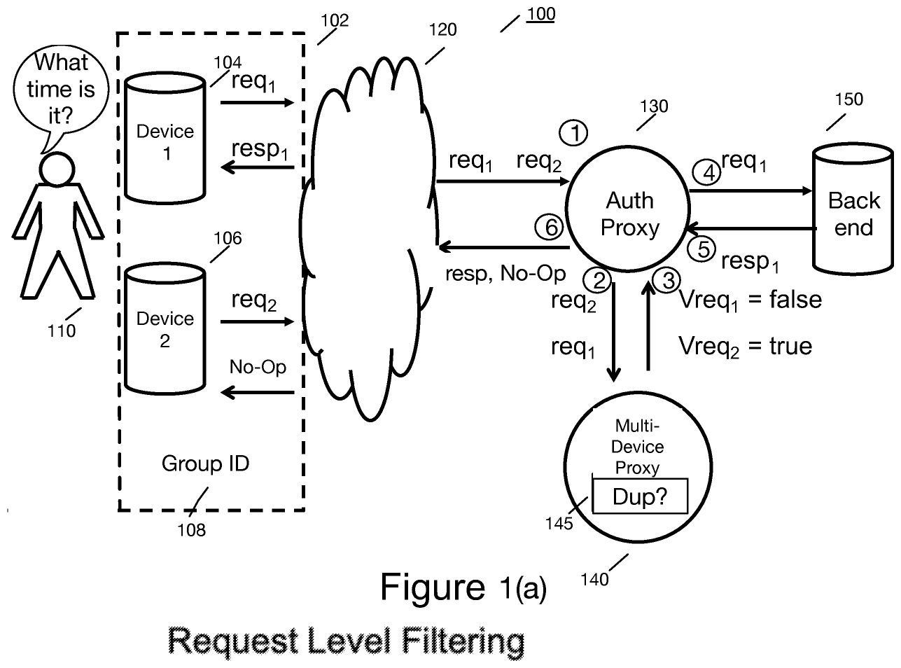

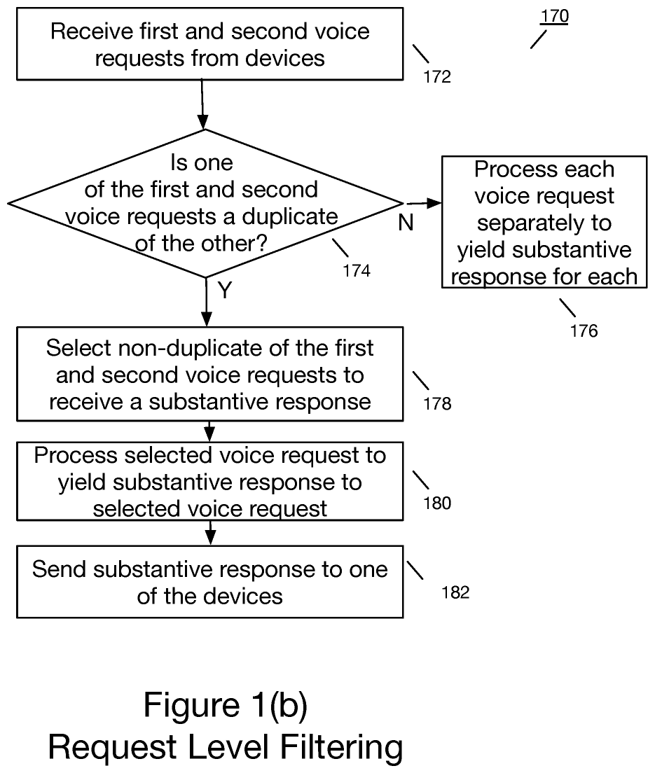

FIG. 1(a) is a diagram 100 of an embodiment of the invention. FIG. 1(b) is a flowchart 170 of a method performed by the embodiment of FIG. 1(a). This method is sometimes referred to as “Request Level Filtering” because duplicates and non-duplicates are determined by looking at voice requests before they are processed by an automatic speech recognition backend of the system.

FIG. 1(a) shows a group of devices 102, such as device1 and device2, although other numbers of devices may be present. In one embodiment, group ID is a text value that distinctly identifies a group. It can be combined with device identifiers, and/or IP addresses to be unique. In one embodiment, group of devices 102 are in proximity to each other and have a same group ID 108, such as, for example, a numeric value, a text group name, a same IP address, or a same geographic location within a predetermined distance. FIG. 1(a) further shows a user 110 within voice range of device1 104 and device2 106. User 110 is close enough to device1 and device2 that device1 and device2 detect spoken utterances from user 110. Other embodiments have additional devices and sometimes other group IDs for some of the additional devices. Some of these additional devices and devices with other group IDs are within voice range of user 110. Thus, while device1 and device2 detect user 110's spoken utterance, other devices (not shown) with other group IDs may also detect user 110's spoken utterance and attempt to provide a substantive response.

In FIG. 1(a), user 110 is asking “What time is it?,” which is an example of a spoken utterance. In this embodiment, both device1 and device2 contain a microphone (mic) or other device suitable for receiving a spoken utterance from user 110 and converting the spoken utterance to digital form to create, respectively, a first voice request (req1) and a second voice request (req2).

This document uses the term “voice request” throughout. It should be understood that “voice request” may be interpreted as a voice request, query, command, or other type of digitized word or sound that is spoken by a user. Thus, for example, a user might say “What's the weather tomorrow?” which is technically a query and not a command. Similarly, for example, the user might say “Turn on the television,” which is technically a command and not a query. In either case, such vocal output is referred to herein as a “spoken utterance” when uttered by a user and as a “voice request” when output in digital form from a voice-sensitive device such as device1 or device2.

In one example, user 110 is in a hotel and group of devices 102 are in the user's hotel room. For example, the room may include a smart speaker and the user may have their cell phone with them. In this example, all devices within the hotel room have the same group ID 108. In another example, group of devices 102 are within hearing distance of user 102 but not necessarily in the same room. In another example, group of devices 102 are within hearing distance of each other. Various methods of assigning a group ID are discussed below.

Device1 sends a voice request req1 to Authorization Proxy (AP) 130 by way of a network 120. Device2 also sends a voice request req2 to AP 130 by way of network 120. Network 120 may be the Internet, an intranet, a private or public network, a mobile network, a digital network, or any other appropriate way of allowing two entities to communicate data.

As shown in FIGS. 1(a) and 1(b), AP 130 receives 172 first and second voice requests from group of devices 102 and determines 174 whether one of the first and second voice requests is a duplicate of the other. Being a duplicate implies that both devices are responding to a same spoken utterance. In the embodiment of FIG. 1(a), AP 130 calls a multi-device proxy (MDP) 140 to make a determination whether one or more voice requests are non-duplicate or whether one or more voice requests are duplicate. MDP 140 has software 145 that determines whether one or more voice requests are duplicates of each other. Other embodiments may perform the methods of MDP 140 and AP 130 in one or multiple elements.

Referring to the embodiment of FIGS. 1(a) and 1(b), software 145 in MDP 140 determines 174 whether at least one of the first and second voice requests is a duplicate of the other. If they are not, processing proceeds 176 for each voice request separately. For example, each voice request may receive a substantive response. If at least one of the first and second voice requests is a duplicate of the other, MDP 140 deems one voice request as non-duplicate and deems the other voice request(s) as duplicate. MDP 140 then returns an indication of whether each of req1 and req2 are duplicate (for example in the Figure, Vreq1=false, Vreq2=true). In the example, false indicates non-duplicate and true indicates duplicate. Examples of the duplicate determination 145/174 of MDP 140 is discussed in detail below in FIGS. 2(a) and 2(b).

In FIGS. 1(a) and 1(b), once one of req1 and req2 has been determined 178 to be non-duplicate and selected to receive a substantive response, that voice request is sent 180 to a backend processor 150 which applies automatic speech recognition and natural language processing to the selected voice request and generates and returns a substantive response (for example, resp1). Backend 150 may access external data sources. For example, in substantive response to the voice request “What's the weather,” backend 150 may access a weather source to obtain a current report. In the described embodiment, the substantive response is returned to AP 130, which determines which of the group of devices the substantive response will be sent to 182.

It will be understood that a similar process is performed in the case where req2 is deemed to be non-duplicate and req1 is deemed to be duplicate. In such a situation, req2 is sent to backend 150, and a substantive response for req2 (resp2) is returned to AP 130 and to one device of the group of devices.

FIGS. 2(a) and 2(b) show two examples of receiving voice requests and processing voice requests by AP 130 and MDP 140 of FIG. 1(a). In one embodiment, MDP 140 receives a series of voice requests from AP 130 one at a time and makes a determination for each of whether it is duplicate or non-duplicate. In another embodiment, MDP 140 receives multiple voice requests together from AP 130 and then determines whether the received multiple voice requests are duplicate or non-duplicate. Methods are possible with combinations of receiving some voice requests together and other groups later, the later group all determined to be duplicates.

Determining Duplicates

FIG. 2(a) is a flowchart 200 of a method used to determine if a voice request is duplicate or non-duplicate in an embodiment of the invention. In the embodiment of FIG. 2(a), the method is performed by MDP 140 although it could be performed by other elements in other embodiments. The method of FIG. 2(a) is sometimes called a “Pick the First” method because a first received voice request is deemed non-duplicate (and selected to receive a substantive response as described below) and subsequent voice requests in the same group and received within a predetermined time window are deemed duplicate. In other words, after a first voice request arrives and is deemed non-duplicate, we deem duplicate the subsequent voice requests that arrive with the same group-id and within a predetermined time window (for example, 1 second) of the initial voice request. Some embodiments, such as ones that operate only with a single group, perform the deeming of non-duplicate and duplicate voice requests by arrival time alone without regard to other considerations such as group ID or volume level.

As successive voice requests are received by AP 130 and passed to MDP 140, the method of FIG. 2(a) is performed for each received voice request. When a current voice request is received 202, MDP 140/145 saves 204 the receipt time and group ID for the current voice request. After a first voice request is received, all voice requests having a same group ID and received within a predetermined time window of receipt of the first voice request are deemed to be duplicates of the first voice request (206). After the predetermined time window has passed, the next received voice query will be deemed a non-duplicate. For example, if user 110 says “what time is it,” and two voice requests are received having the same group ID within a predetermined time window, it is reasonable to assume that all voice requests after the first voice request received from the same group at almost the same time are duplicates (208). Often, a voice request is received first because the device is closest to the user and the user's spoken utterance is received by the device first. A determination of duplicate or non-duplicate is returned 212 to AP 130 for the current voice request. A time window should be longer than the longest difference in reception time of two requests resulting from one user utterance, accounting for possible network latency, device processing differences, and soundwave propagation time from the user's mouth to different devices within audible range. A time window should be shorter than the amount of time that a user would expect to be able to make two separate queries and be understood. In one implementation, the predetermined time window is one second, although other time windows can be used.

It should be understood that a similar “Pick the First” method can also be performed for a group of voice requests sent to the MDP together, as long as each voice request has an associated group ID and a timestamp.

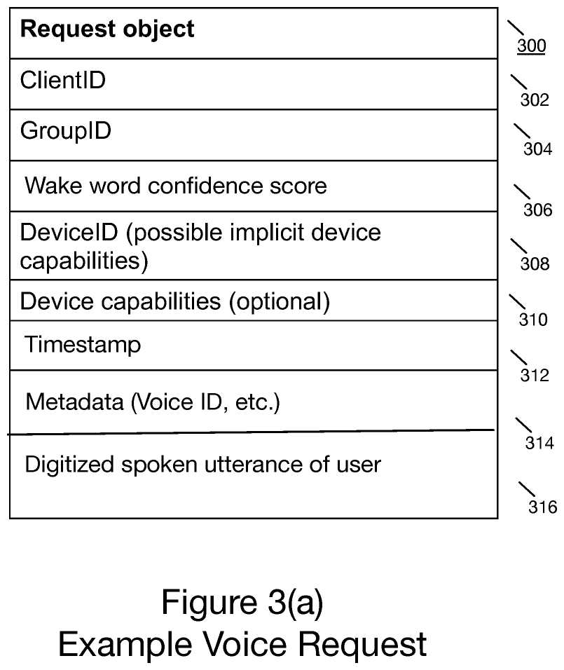

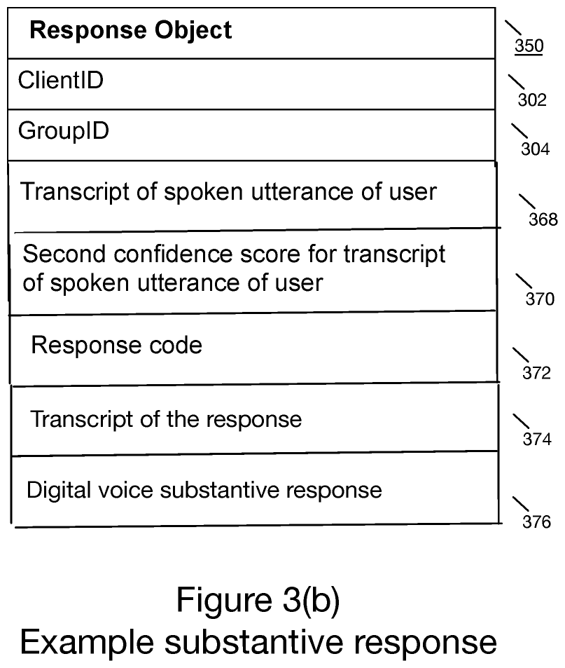

FIG. 2(b) is a flowchart 250 of another method used to determine if voice requests are duplicate or non-duplicate in an embodiment of the invention. In the embodiment of FIG. 1(a), the method is performed by MFP 140/145 although it could be performed by other elements in other embodiments. The method of FIG. 2(b) is sometimes called a “wake word confidence” method. As shown in the example of FIG. 3, each voice request contains a wake word confidence score 306. Many devices send user voice requests to an AP server only when invoked by a local phrase spotter detecting a wake word. Phrase spotters tend to run on low-cost or low-power processors and are often implemented as classifier neural networks that run constantly. The phrase spotter continuously checks received audio, sample by sample or frame by frame, for the wake word and outputs a probability that the wake word has been recently spoken. When the probability exceeds a threshold, the phrase spotter wakes the device and provides the probability as a wake word confidence score. Though the phrase spotter wakes the device as soon as the probability exceeds the threshold by even a tiny bit, the probability may continue to increase for a period of time after crossing the threshold. When the device wakes, it prepares to send a voice request to the AP server. If the preparation takes longer than the time for the phrase spotter probability value to peak, the device can include the maximum probability value reached by the phrase spotter with the voice request. After sending the voice request, the maximum probability value is discarded until the phrase spotter probability recedes below the threshold. A wake word confidence score 306 indicates a confidence score of the device that it correctly heard a “wake word” spoken by the user to wake up a device and alert it that a spoken utterance will follow. A wake word confidence score is also called a “first confidence score” in this document. Some example wake words are “Hey Siri,” “OK Google,” “Okay Hound,” etc. Often, a high wake word confidence score indicates that the device is closest to the user because a device close to the user tends to have a higher signal to noise ratio of speech and therefore the device more confidently detects the wake word.

Systems that apply the wake word confidence method, upon detecting a wake word recognition score above a threshold for a segment (such as a 10 millisecond frame) of audio, store the score temporarily. Some such systems may update the score if an even higher wake word recognition score occurs within a period of time shorter than a wake word (such as 250 milliseconds). According to the wake word confidence method, a device 102 includes the most recent stored wake word confidence score with each voice query that it sends to AP 130.

When the multiple voice requests are received (252), MDP 140 checks whether the voice requests have the same group ID (254) and were received within a predetermined time window (256), such as, for example, one second. If the voice requests were not received within the predetermined time window or if the voice requests did not have the same group ID, they are not duplicates (260). If the voice requests are received within the predetermined time window, the wake word confidence scores are checked. (In other embodiments, all voice requests received within a predetermined time window are looked at to determine duplicates without checking the group ID). A received voice request with a highest wake word confidence score is deemed non-duplicate and the other voice request(s) are deemed to be duplicate of the non-duplicate voice request (258). A determination of duplicate or non-duplicate is returned to AP 130 for each voice request (262). For example, when user 110 says the wake word, device1 may be farther away from user 110 but have a better microphone and thus have a higher confidence score for the wake word. Device2 may be closer, receive the wake word earlier, and send a voice request earlier, but because it has a lower wake word confidence score, its voice request is deemed duplicate. In this embodiment, looking at a wake word confidence score is desirable because it is likely to choose a voice request from a device having a better microphone, which results in a better heard spoken utterance. It should be understood that the method of FIG. 2(b) can be generalized for more than two multiple voice requests. It will also be understood that the method of FIG. 2(b) can be used without considering an explicit group ID. For example, the devices may have a similar geographic location and thus be considered to be in the same group even though they have no explicit group ID.

In other embodiments, the user may pre-indicate a preferred device that will be chosen in a situation involving potential duplicates. In this case, voice requests from the preferred device will always be deemed non-duplicate and voice requests from other devices in the group, if received within a predetermined time window as a voice request from the preferred device, are deemed duplicate. Such a decision can be, for example, pre-determined by user-set configurable preferences. In other embodiments, a random voice request received within a predetermined time window can be chosen in a situation involving potential duplicates. In some embodiments, if the voice ID 314 of the speaker differs in two voice requests, neither of the voice requests will be a duplicate since they came from different sources, i.e., different speakers. Such an embodiment conditions the deeming of a voice request as a duplicate on determining that the first and second voice requests are from the same source.

Deciding to which Device to Send Substantive Response

Returning to FIGS. 1(a) and 1(b), in one embodiment, the substantive response (for example, resp1) is returned (182) to the device that sent the non-duplicate voice request. Other embodiments, however, may send the substantive response to a different device than the device from which the non-duplicate voice request was received. In one embodiment, the user sets a device that will receive all substantive responses. For example, user 110 may set their mobile phone as a device that receives all substantive responses, no matter where a voice request is received from. As another example, the user may determine that all substantive responses will be sent to their home assistant device, even if it did not originate a non-duplicate request. These examples are only practical for groups of devices that are physically close to each other. Even a group that spans a long hallway would be ineffective if a user makes a voice request to a device on one end of the hallway and the substantive response is provided by a chosen device at the other end of a hallway. This problem is avoided by embodiments in which all substantive responses should be sent to whichever device is physically closest to the user. As another example, the substantive response may be sent to the device based on functions. For example, a substantive response fora voice request of “play a song” may be sent to the device with better speakers.

C. Voice Request and Substantive Response Data Structure Examples

FIG. 3(a) is an example data structure of a voice request data structure 300 such as a voice request sent from a device to AP 130. The data structure includes a client ID 302, a group ID 304, a wake word confidence score 306, a device ID (possibly implying certain device capabilities) 308, device capabilities (optional) 310, a timestamp 312 and, in this embodiment, a digitized capture of the spoken voice command 316 uttered by user 110. Data structure 300 also has a voice ID metadata 314, which identifies a speaker. If a speaker asks about their calendar, for example, it is important to know which person asked (morn, dad, child, etc.). For that, devices can compute a voice fingerprint or use some other possible method of identifying the speaker.

FIG. 3(b) is an example data structure of a substantive response 350 from backend 150/450. It will be understood that other implementations of the invention may contain additional or fewer fields. The substantive response includes a transcript of the digitized spoken utterance of the user (368) using automatic speech recognition. For example, this may be the ASCII characters for “What time is it?” if that is the text string that backend 150/450 obtains as a result of automatic speech recognition of the digitized utterance of the user 316. The substantive response also includes an automatic speech recognition confidence score 370, which is a confidence score of the conversion from digitized spoken utterance 316 to text 368. As discussed in connection with FIG. 4(a), backend 450 may determine a slightly garbled version of the user utterance such as “What dime is it?” for the digitized voice received from one of the devices. As with phrase spotters, automatic speech recognition is performed by analyzing speech audio by probabilistic models. The probabilities of recognized phonemes or words or a combination may be output as the automatic speech recognition score. Usually, incorrect transcriptions will have relatively low automatic speech recognition scores. In this example, backend 450 may give a low automatic speech recognition confidence score 370 as this is not a common phrase according to a language model of broadly spoken English speech.

Substantive response 350 further includes a response code 372, which indicates success or failure (different failure types may have different codes). In some embodiments, substantive response 350 includes a transcript of the result 374 and a digital voice substantive response of the result 376. For example, if the request asks “what time is it?” the result would include the text “it's 2 pm”, plus the digital voice data of a voice saying “it's 2 pm.” As will be recognized by a person of skill in the art, backend 450 interfaces with any number of appropriate internal and/or external information sources to obtain the substantive response.

D. Response Level Filtering

FIG. 4(a) is a diagram of an embodiment of the invention. FIG. 4(a) shows a group of devices 402, such as device1 and device2, although other numbers of devices may be present and receiving a user's spoken utterance. The embodiment of FIG. 4(a) performs a method called “Response Level Filtering” in which duplicate and non-duplicate voice requests are determined after the voice requests have been processed by backend 450, as discussed below in more detail. Once the substantive responses for each received voice request are received from backend 450, the substantive responses (and possibly the voice requests) are sent to MDP 440 for a determination 445 of whether the associated voice requests are duplicate or non-duplicate. Other embodiments may perform the methods of MDP 440 and AP 430 in one or multiple elements.

FIG. 4(b) is a flowchart 470 of a method performed by the embodiment of FIG. 4(a). In the described embodiment, an Authorization Proxy (AP) 430 receives first and second voice requests (reg1 and req2) from the group of devices, one voice request per device (472). In the embodiment of FIG. 4(b), AP 430 passes the first and second voice request to a backend 450 and backend 450 sends (474) respective responses (resp1 and resp2) for the voice requests to AP 430. In one embodiment, backend 450 passes additional information back to AP 430 as discussed below. AP 430 and MDP 440 determine (476), based on the substantive responses, whether the voice requests are duplicate or non-duplicate as discussed below in detail. If neither of the first and second voice requests are duplicate, both voice requests are processed separately (477).

While it may seem that voice requests based on a same spoken utterance by the user will be the same and will result in the same substantive responses from backend 450, this is not always the case. As an example, the devices may have differing qualities of microphones and record the spoken utterance differently, resulting in slightly different digitized spoken utterance 316 in the voice requests from the different devices (for example, “What time is it” vs “What dime is it?”). As another example, the devices may be different distances from the user and the differentials in distance may cause the devices to record different qualities of the spoken utterance, resulting in slightly different digitized spoken utterance 316 in the voice request from the different devices.

As another example, certain devices are only able to respond to a subset of spoken words and backend 450 may be aware of this limitation. Thus, “What time is it?” may result in backend 450 sending a substantive response of a time for one device (based on the device ID) but a substantive response having nothing to do with time for another device (based on the device ID) if that device is not able to provide times of day. As another example, a substantive response to a voice request to “turn on the light”, will not be sent to a requesting device if that device cannot control lights, but will be sent to a device that can control lights.

Backend 450 performs natural language processing on the digitized spoken utterance 316 in each voice request, producing an interpretation and an interpretation score. Backend 450 uses the interpretation to look up requested information or assemble instructions for a client to perform an action. Backend 450 uses the result to generate a substantive response as shown in the example of FIG. 3(b). The substantive response carries the requested information or action command. In some embodiments, backend 450 sends an interpretation confidence score 370 that represents a confidence level in understanding the voice request. This score can cover, for example, an automatic speech recognition confidence score (how well the speech recognition worked) or an interpretation confidence score (how meaningful the words are, not so much how likely the words are correctly recognized).

Returning to FIG. 4(b), the following paragraphs discuss various embodiments of methods performed by AP 430 and MDP 440/445 to determine (476) whether voice requests are duplicate or non-duplicate based on the substantive responses from backend 450.

Comparing Spoken Utterance Transcripts

In some embodiments, MDP 440 can determine that the transcripts of the spoken utterances 368, while not the same, are within a request similarity threshold value. For example, transcript values 368 of “What time is it” and “What dime is it” are very close to each other, and if the strings differ by no more than a predetermined request similarity threshold value (e.g., one character), they are deemed to be identical, even though they are not exactly identical. Some embodiments save one or more phoneme sequence hypotheses used to compute the transcription and compute an edit distance between one or more phoneme sequence hypothesis of two voice queries to compute a phoneme edit distance. The two voice queries are deemed identical if their edit distance is less than a threshold (e.g., two phonemes). Various implementations can use different request similarity threshold values. As a further example, transcript values 368 of “What time is it” and “Turn on the lights” probably differ sufficiently that neither would be deemed duplicate, even if they are in the same group and arrived within a predetermined time window. In such an example, there may be two users speaking at the same time. Thus, neither of the voice requests is duplicate and both users should receive a substantive response. Deeming a voice request non-duplicate can be, for example, done on a first come first served decision, based on a random decision, or based on a preferred device. Some embodiments also require the voice requests to have a same group ID and/or be received within a predetermined time window for at least one to be a duplicate.

Comparing Response Transcripts

In some embodiments, if multiple substantive responses associated with the voice requests have an identical (or near identical) “transcript of the response” 374, one of the associated voice requests is deemed to be non-duplicate and the other voice request(s) are deemed duplicate. One embodiment uses a response similarity threshold value to aid in this determination. As an example, when the response similarity threshold value is set to “no differences allowed,” and the transcripts 374 of the first and second substantive responses are both “it's two o'clock,” one of the corresponding voice requests will be deemed non-duplicate, and the other(s) will be deemed duplicate. Deeming a non-duplicate can be, for example, done on a first come, first served decision; based on a random decision; or based on a preferred device. Some embodiments also require the voice requests to have a same group ID and/or be received within a predetermined time window for at least one to be a duplicate.

Highest Automatic Speech Recognition Confidence Score

In one embodiment, MDP 440 determines that a voice request associated with a substantive response having a highest automatic speech recognition confidence score 370 is non-duplicate (and the other(s) are deemed duplicate). Some embodiments also require the voice requests to have a same group ID and/or be received within a predetermined time window for at least one to be a duplicate.

Background Noise of Voice Request

As described above with regard to recognizing wake words, speech audio has a signal to noise ratio (SNR). SNR is one type of noise value. Usually, when multiple microphones capture speech audio, the audio captured from the closest microphone has the best SNR. A good SNR generally gives more accurate speech recognition and, as a result, a better possibility for a virtual assistant to understand user requests and provide appropriate substantive responses. Therefore, when deeming one of multiple duplicate voice requests non-duplicate for the purpose of processing and responding, it is sometimes advantageous to choose the voice request with the highest SNR, the lowest overall noise level, or the least disruptive noise characteristics as non-duplicate. Noise level and level of noise of disruptive characteristics are also types of noise values.

SNR can be calculated as the ratio of power represented in an audio signal filtered for voice spectral components to the power represented in the unfiltered audio signal. SNR is typically expressed in decibels. SNR can be computed over the full duration of a digitized spoken utterance. However, that requires waiting until receiving the end of the digitized spoken utterance. SNR can also be computed incrementally on windows of audio. One approach would be to use the highest, lowest, or average SNR across a number of windows to compute SNR for a voice request.

Overall noise level can be computed by filtering an audio signal to remove voice spectral components and computing the power of the signal. Computing noise across a full voice request can be useful to disregard as duplicate a voice request captured by a microphone right next to a whirring fan. Computing noise level across time windows and storing the max level can be useful for disregarding as duplicate a voice request that includes a transient noise such as a slamming door.

Other approaches to detecting and measuring noise are possible using models such as neural networks trained on audio samples of different noise types. Such models can also be applied for the purpose of noise reduction or removal from speech audio to assist the accuracy of processing voice requests.

In one embodiment, MDP 440 determines that a voice request associated with a substantive response having the least background noise value is non-duplicate. In some embodiments, backend 450 determines the amount of background noise that the digitized spoken utterance of the user 316 has and includes this information in the substantive response sent to AP 430. Such background noise may lead to incorrect speech recognition of the voice request. Thus, a voice request with the lowest background noise will be chosen as non-duplicate in some embodiments. It should be noted that audio quality is not always indicative of closeness depending on the diversity of the group of devices. For example, Some embodiments also require the voice requests to have a same group ID and/or be received within a predetermined time window for at least one to be a duplicate.

Volume Level of Voice Request

In one embodiment, MDP 440 determines that a voice request having the highest volume value is non-duplicate. In some embodiments, backend 450 determines a volume of the digitized spoken utterance of the user 316 and includes this information in the substantive response sent to AP 430. In some embodiments, devices determine a volume level and include that information with their voice requests. This is generally most practical if devices are homogenous since different types of devices have different microphones with different sensitivities that would make comparison of volumes meaningless. Volume is sometimes an indication of the closest device. Thus, a voice request with the highest volume value will be chosen as non-duplicate in some embodiments. Some embodiments also require the voice requests to have a same group ID and/or be received within a predetermined time window for at least one to be a duplicate.

One way to measure volume is to find the highest sample value or sample with the highest magnitude in the voice request. This approach is ineffective if there is a large transient noise, such as a closing door, during a voice request since if the noise source is closer to the device that is further from the user. Another way to measure volume is to compute the average magnitude or square of the root-mean-square (RMS) of the values of samples in the voice query. The RMS approach is ineffective if a device has its microphone near a source of constant noise such as an electric motor or fan. A combined approach is possible or other approaches such as filtering the microphone signal for just voice frequencies or measuring at multiple peaks spaced significantly far apart in time or measuring magnitude above a long-term noise floor.

Combination of Substantive Response-Based and Voice Request-Based Signals

In one embodiment, MDP 440 determines that a voice request associated with a substantive response is non-duplicate based on a combination of one or more of the above-listed methods and a method based on the voice request alone. For example, a non-duplicate determination might look at the wake word confidence score and the volume, or a first-received voice request unless the automatic speech recognition confidence score is below a predetermined threshold value. One embodiment tries to make a duplicate/non-duplicate determination based on voice request-based factors and only uses substantive response based factors if it cannot make a decision based on the voice request alone. Some embodiments also require the voice requests to have a same group ID and/or be received within a predetermined window for at least one to be a duplicate.

Combination of Substantive Response-Based Signals

In one embodiment, MDP 440 determines that a voice request associated with a substantive response is non-duplicate based on a combination of two or more of the above-listed methods. For example, it could look at the automatic speech recognition confidence score and the volume, or any other combination. Some embodiments also require the voice requests to have a same group ID and/or be received within a predetermined time window for at least one to be a duplicate.

E. Determining Group ID

In one embodiment, devices are preassigned a group ID. For example, all devices in a particular space such as a hotel room may have the same group ID. This will result in only voice requests from devices in a particular hotel room being duplicate. Voice requests from other closely located devices, such as ones in an adjacent hotel room will definitely not be deemed duplicate. If two users in adjacent rooms ask for the time at the exact same time, both users will get a substantive response issuing from a device in their room.

In one embodiment, group IDs are dynamically assigned. One device sends a signal, such as a tone outside the range of human hearing and all other devices that are close enough to hear the sent tone communicate to decide on a group ID. To accomplish this, devices must continuously attempt detection of such tones. Such tones can be modulated to include identifying information such as a serial number or URL. Other signaling methods, such as Bluetooth signals, can alert nearby devices that they might be appropriate to include in a group. When devices detect another within Bluetooth range they can then perform an audible detection procedure to determine whether they are within the same audible space as opposed to, for example, being on opposite sides of a relatively sound-proof wall. Alternately, the group may elect one device to relay all voice requests for the group.

Thus, if a user in a large space utters a spoken utterance, all devices within earshot are part of a group with the same group ID and only one will answer, although multiple devices may send a voice request. Assigning a group ID will be repeated periodically to account for devices being moved from one location to another. In this embodiment, it is not necessary to re-set a group ID when devices are physically moved. In some embodiments, the user will be asked for permission to add a device to a group. For example, as a user walks around with a mobile phone, the mobile phone can be dynamically assigned to a group if the user is asked and grants permission.

In one embodiment, group IDs are dynamically assigned by location. In this embodiment, devices are aware of their location, either as latitude/longitude, GPS coordinates, a location code, or other appropriate method. In such an embodiment, devices may send their latitude/longitude or location code instead of or in addition to a group ID. Such embodiments use the methods described above, but substitute a coarse-grained location for group ID.

In one embodiment, group IDs are dynamically assigned by IP addresses. In such an embodiment, devices may send their IP address instead of or in addition to a group ID. Such embodiments use the methods described above, but substitute IP address for group ID.

In one embodiment, the group ID is assigned dynamically but it is limited to a physical area, such as a hotel room. Thus, devices may change their group IDs as they move, but they are not necessarily in a group with all devices within an audible range.

In one embodiment, an AP and/or MDP can access a mapping of unique device IDs to groups. Therefore it is not required for devices to send a group ID with a voice request. In an embodiment, the device ID itself is used as a group ID, and multiple devices share the same device ID.

F. Hardware Example

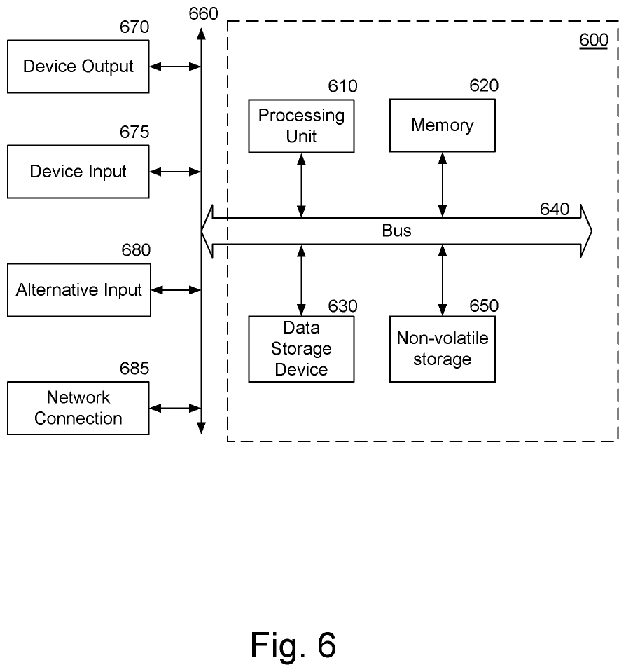

FIG. 6 is a block diagram of one embodiment of a computer system that may be used with the present invention. It will be apparent to those of ordinary skill in the art, however that other alternative systems of various system architectures may also be used. A computer system such as shown in FIG. 6 may be used to implement, for example, device1 and device2 in FIGS. 2(a) and/or 4(a). Similarly, a computer system such as shown in FIG. 6 may be used to implement, for example, the AP, MDP, and backend elements in FIGS. 2(a) and/or 4(a). The functionality of these devices and elements are embodied, for example, in computer code stored in a memory or storage system of the system as described below.

The data processing system illustrated in FIG. 6 includes a bus or other internal communication means 640 for communicating information, and a processing unit 610 coupled to the bus 640 for processing information. The processing unit 610 may be a central processing unit (CPU), a digital signal processor (DSP), or another type of processing unit 610.

The system further includes, in one embodiment, a random access memory (RAM) or other volatile storage device 620 (referred to as memory), coupled to bus 640 for storing information and instructions to be executed by processor 610. Main memory 620 may also be used for storing temporary variables or other intermediate information during execution of instructions by processing unit 610.

The system also comprises in one embodiment a non-volatile storage 650 such as a read only memory (ROM) coupled to bus 640 for storing static information and instructions for processor 610. In one embodiment, the system also includes a data storage device 630, such as a magnetic disk or optical disk and its corresponding disk drive, or flash memory or other storage which is capable of storing data when no power is supplied to the system. Data storage device 630 in one embodiment is coupled to bus 640 for storing information and instructions.

The system may further be coupled to an output device 670, such as an LED display or a liquid crystal display (LCD) coupled to bus 640 through bus 660 for outputting information. The output device 670 may be a visual output device, an audio output device, a Smarthome controller, and/or tactile output device (e.g., vibrations, etc.)

An input device 675 may be coupled to the bus 660. The input device 675 may be a text input device, such as a keyboard including alphanumeric and other keys, for enabling a user to communicate information and command selections to processing unit 610. An additional user input device 680 may further be included. One such user input device 680 is cursor control device 680, such as a voice control, a mouse, a trackball, stylus, cursor direction keys, or touch screen, may be coupled to bus 640 through bus 660 for communicating direction information and command selections to processing unit 610. In the described embodiments of the invention device1 and device 2 have microphones that receive spoken utterances of the user.

Another device, which may optionally be coupled to computer system 600, is a network device 685 for accessing other nodes of a distributed system via a network. The communication device 685 may include any of a number of commercially available networking peripheral devices such as those used for coupling to an Ethernet, token ring, Internet, or wide area network, personal area network, wireless network or other method of accessing other devices. The communication device 685 may further be any other mechanism that provides connectivity between the computer system 600 and the outside world.

Note that any or all of the components of this system illustrated in FIG. 6 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 620, mass storage device 630, or other storage medium locally or remotely accessible to processor 610.

It will be apparent to those of ordinary skill in the art that the system, method, and process described herein can be implemented as software stored in main memory 620 or read only memory 650 and executed by processor 610. This control logic or software may also be resident on an article of manufacture comprising a computer readable medium having computer readable program code embodied therein and being readable by the mass storage device 630 and for causing the processor 610 to operate in accordance with the methods and teachings herein.

The present invention may also be embodied in a handheld or portable device containing a subset of the computer hardware components described above. For example, the handheld device may be configured to contain only the bus 640, the processor 610, and memory 650 and/or 620.

The handheld device may be configured to include a set of buttons or input signaling components with which a user may select from a set of available options. These could be considered input device #1 675 or input device #2 680. The handheld device may also be configured to include an output device 670 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 610, a data storage device 630, a bus 640, and memory 620, and no input/output mechanisms, or only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In one embodiment, the device may not provide any direct input/output signals, but may be configured and accessed through a website or other network-based connection through network device 685.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 610. A machine-readable medium includes any mechanism for storing information in a form readable by a machine (e.g., a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g., carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A computer-implemented method of processing voice requests, comprising:
receiving a first voice request from a first device in a group of devices;
receiving a second voice request from a second device in the group of devices;
deeming one of the first and the second voice requests a non-duplicate voice request and deeming the other of the first and the second voice requests a duplicate voice request;
sending a substantive response for the deemed non-duplicate voice request to the device from which the deemed non-duplicate voice request was received; and
refraining from sending a substantive response for the deemed duplicate voice request to the device from which the deemed duplicate voice request was received.

2. The method of claim 1, wherein the first and second voice requests are deemed to be duplicate only if they are determined to have a same group ID.

3. The method of claim 2, wherein a group ID of the group of devices is determined dynamically by the group of devices.

4. The method of claim 3, wherein the determining dynamically comprises sending an audio signal having a frequency outside of human perception by one of the devices of the group of devices and receiving the audio signal by another device of the group of devices, wherein the one device and the another device determine the group ID based on the signal.

5. The method of claim 1, wherein deeming one of the first and the second voice requests a non-duplicate voice request and deeming the other of the first and the second voice requests a duplicate voice request further comprises performing a “Pick the First” method.

6. The method of claim 1, wherein the deeming one of the first and the second voice requests a non-duplicate voice request and deeming the other of the first and the second voice requests a duplicate voice request further comprises deeming that the voice request with a highest wake word confidence score is non-duplicate.

7. The method of claim 1, further comprising:
performing automatic speech recognition on the first and second voice requests to produce first and second automatic speech recognition confidence scores,
wherein deeming one of the first and the second voice requests a non-duplicate voice request and deeming the other of the first and the second voice requests a duplicate voice request further comprises deeming that the voice request whose substantive response has a highest automatic speech recognition confidence score is non-duplicate.

8. The method of claim 1, wherein the deeming one of the first and the second voice requests a non-duplicate voice request and deeming the other of the first and the second voice requests a duplicate voice request further comprises determining that the voice request whose substantive response has a lowest noise value is non-duplicate.

9. The method of claim 1, wherein the deeming one of the first and the second voice requests a non-duplicate voice request and deeming the other of the first and the second voice requests a duplicate voice request further comprises determining that the first and second voice requests are from a same source.

10. The method of claim 1 further comprising:
performing natural language processing on the non-duplicate voice request to generate the substantive response.

11. The method of claim 1, wherein deeming one of the first and the second voice requests a non-duplicate voice request and deeming the other of the first and the second voice requests a duplicate voice request, further comprises:
calling a multi-device proxy for the first and second voice requests; and
receiving from the multi-device proxy a determination of which of the first and second voice requests are non-duplicate and duplicate.

12. The method of claim 11, wherein the first and second voice requests are sent to the multi-device proxy separately, as they are received.

13. The method of claim 11, wherein the first and second voice requests are sent to the multi-device proxy together, after both have been received.

14. The method of claim 1, wherein deeming one of the first and the second voice requests a non-duplicate voice request further comprises:
determining a volume value for the first voice request and the second voice request; and
deeming non-duplicate the voice request whose volume value is highest.

15. A computer-implemented method of processing voice requests, comprising:
receiving a first voice request from a first device in a group of devices;
receiving a second voice request from a second device in the group of devices;
performing automatic speech recognition and natural language processing on the first voice request to generate produce a first substantive response and on the second voice request to generate produce a second substantive response;
deeming one of the first and the second voice requests a non-duplicate voice request and deeming one of the first and the second voice requests a duplicate voice request based on the first and second substantive responses and identifying one of the first and second substantive responses to be sent based on the deeming of the non-duplicate voice request;
sending the identified substantive response to a device in the group of devices; and
refraining from sending a substantive response for the deemed duplicate voice request to other devices in the group of devices.

16. The method of claim 15, wherein deeming one of the first and the second voice requests a duplicate voice request further comprises:
determining that the first voice request and the second voice request have a same group ID.

17. The method of claim 15, wherein deeming one of the first and the second voice requests a non-duplicate voice request further comprises:
determining that the voice request whose substantive response has a lowest noise value is non-duplicate.

18. The method of claim 15, wherein deeming one of the first and the second voice requests a duplicate voice request further comprises:
determining that transcripts of the first and second spoken utterances are identical within a request similarity threshold value.

19. The method of claim 15, wherein deeming one of the first and the second voice requests a duplicate voice request further comprises:
determining that transcripts of the first and second substantive responses are identical within a response similarity threshold value.

20. The method of claim 15, wherein deeming one of the first and the second voice requests a non-duplicate voice request further comprises:
deeming the voice request that has a highest volume value is non-duplicate.
